(19) United States
(12) Patent Application Publication
(10) Pub. No.: US 2006/0046060 A1
(43) Pub. Date: Mar. 2, 2006

(54) Wear-resistant coating and process for producing it

(75) Inventors: Bodo Rorig, Weisendorf (DE); Tim Matthias Hosenfeldt, Ebern (DE)

Correspondence Address: OSTROLENK FABER GERB & SOFFEN, 1180 AVENUE OF THE AMERICAS, NEW YORK, NY, 100368403, US

(73) Assignee: INA Schaeffler KG

(21) Appl. No.: 11/211,052

(22) Filed: Aug. 24, 2005

(30) Foreign Application Priority Data
Aug. 26, 2004 (DE) 102004041234.0

(51) Int. Cl. B32B 9/00

(52) U.S. Cl. 428/408

(57) ABSTRACT

A process for producing a wear-resistant coating and a wear-resistant coating on a surfaces of machine or engine parts which are exposed to frictional wear. This has in particular use for internal combustion engines. The coating comprises at least one metal-free, amorphous hydrocarbon layer which includes sp²- and sp³-hybridized carbon applied to the surface of the machine part, for reducing friction and increasing the wear resistance of the surface of the machine or engine part.

### FIELD OF THE INVENTION

The present invention relates to a wear-resistant coating on predetermined surfaces of machine or engine parts which are exposed to frictional wear, and to a process for producing a wear-resistant coating of this type, in particular for machine or engine parts in internal combustion engines.

Although it can be applied to any desired machine or engine parts, the present invention and the object on which it is based are explained in more detail in connection with engine parts for internal combustion engines, in particular on the basis of a shiftable drag lever which can be used in the valve gear of an internal combustion engine to switch off valves/cylinders or to switch over the valve stroke.

A drag lever of this type for a valve gear of an internal combustion engine is known, for example, from U.S. Pat. No. 3,542,001. The fact that considerable wear, which reduces the service life of the valve gear, can occur as a result of the friction between a supporting element and a spherical cap-shaped cutout, i.e. steel-steel friction, has proven to be disadvantageous for the drag lever described in this document. It has been attempted to reduce this wear, i.e. the abrasion phenomena which occur under long-term load of contact partners, and in general terms the undesirable change to the surface resulting from extremely small particles floating off as a result of mechanical and/or tribological loads, by subjecting the partners involved to a thermal or thermochemical treatment to produce defined properties.

In general, modern valve gear components, for example drag levers of this type, are subject to increasing demands with regard to wear resistance and preservation of resources. The reasons for the need for increased wear resistance lie in the increasingly high loads and stresses in the tribological system comprising control cam and cam follower. The reasons for this lie in new designs of engine, such as gasoline and diesel direct injection systems, with ever greater injection pressures, an increasing proportion of abrasive particles in the lubricant, the absence of an oil supply to the friction partners, which leads to an increased proportion of mixed friction, and the increasing use of tribologically unfavorable steel cams in order to reduce costs and mass. The reduction of the friction losses in the valve gear, with a resulting fuel saving combined, at the same time, with an increase in the service life of the valve gear as a whole, represents an important contribution to the preservation of resources. To effectively reduce the friction losses, it is necessary to lower the frictional torque throughout the entire engine speed range, i.e. to shift the entire Stribeck curve downward.

One prior art approach provides running surfaces of machine or engine parts exposed to frictional wear with wear-resistant layers which, depending on the particular application, preferably consist of metals applied by electroplating or of metals and/or metal alloys applied in a thermal spraying process, and if appropriate, with hard material additions.

However, one drawback which has been found for this approach is that metal layers applied by thermal spraying have a relatively low strength. In order to improve the strength, it is therefore known to remelt the metal layers after they have been applied, for example by plasma jets, laser beams, electron beams or by an arc, in such a manner that the sprayed materials are mixed in molten form with the base material which is simultaneously melted in the surface region, to form an alloy. However, the remelting alloying operation produces inhomogeneous zones of different compositions in which both the base material and the layer material may dominate. If the proportion of base material is too high, the wear to the layer then becomes too high, and if the proportion of base material is low, in some layer combinations there is a risk of the formation of macrocracks, which means that these layers cannot be used. In such a case, frictional loading may cause undesirable adhesive wear to the layers.

For example, it is customary for drag levers of this type to be subjected to case hardening. However, it has been found that despite the resulting surface hardening, high levels of wear continue to occur at high contact pressures, as before.

DE 196 44 374 A1 discloses a drag lever for a valve gear of an internal combustion engine. One end of the lever has a spherical cap-shaped cutout, by means of which it is mounted pivotably with respect to a spherical end of a supporting element. The other end is operatively connected to a gas exchange valve. To reduce the wear which occurs, that surface of the drag lever, or more accurately of the supporting element, which is exposed to wear consists of a steel grade 16MnCr5, i.e. comprising 0.16% of carbon, 1.25% of manganese and 1.25% of chromium. This supporting element is subjected to case-hardening for two hours at approx. 900° C. and then quenched in an oil bath.

However, the fact that the individual process steps are complex and expensive and do not provide sufficient wear resistance has proven to be a drawback of this prior art approach.

Furthermore, the Applicant is aware of drag levers having sliding surfaces which are treated with heat treatment or coating processes, such as nitrocarburizing or plasma nitriding, to protect them from wear. Applications in which the sliding surfaces of the drag levers are realized by a soldered-on hard metal plate are also known.

However, the fact that the known coatings do not offer sufficient resistance to wear under the lubricating conditions and contact pressures which occur with shifting drag levers has proven to be disadvantageous for these prior art approaches. Furthermore, spraying with oil is additionally required to reduce the susceptibility to wear. A further drawback is that the friction caused by the sliding surfaces in the system with shifting drag levers cannot be compensated for by conventional coating processes. Furthermore, additionally soldered-on hard metal plates increase both the costs and the mass of the individual drag levers in a detrimental way.

### SUMMARY OF THE INVENTION

Therefore, it is an object of the present invention to provide a wear-resistant coating and a process for producing a coating of this type which eliminate the abovementioned drawbacks and in particular ensure wear resistance over the entire service life of an internal combustion engine with a reduced friction coefficient.

According to the invention, this object is achieved, in terms of the apparatus, by a wear-resistant coating of the invention and by a process of the invention.

The idea of the present invention is based consists of a wear-resistant coating on predetermined surfaces of machine or engine parts which are exposed to frictional wear consisting of at least one metal-free, amorphous hydrocarbon layer which includes sp²- and sp³-hybridized carbon applied to the predetermined surface of the machine or engine part in order to reduce friction and increase the wear resistance of the predetermined surface of the machine or engine part.

The present invention has the advantage over the prior art that the wear resistance, for example in the sliding contact with the camshaft in the case of shiftable drag levers, is increased compared to the prior art. Furthermore, the friction in the sliding contact with the camshaft in shiftable drag levers is reduced, as compared to the prior art. Moreover, the drag levers or other machine or engine parts can be produced at low cost, on account of the process involving low manufacturing costs.

According to a preferred refinement, the amorphous hydrocarbon layer has a hydrogen content of at most 16 atomic %. As a result, the predetermined surface of the machine part or drag lever has little tendency to adhere to the metallic opposing body, i.e. the cam, a high resistance to abrasive wear, a high chemical stability, high mechanical strength and high hardness/elasticity modulus ratios. A higher hydrogen content could lead to undesirable compounds being formed with lubricants or the like.

The amorphous hydrocarbon layer preferably contains less than 1 atomic % of process-related impurities, for example O or Ar atoms, metals or the like.

According to a further preferred embodiment, the overall coating is from approximately 1.0 mm to 5.0 mm thick, with the amorphous hydrocarbon layer preferably being from 0.8 mm to 2.5 mm thick. Layer thicknesses of this nature cause such a slight change to the dimensions of the machine or engine parts that there is no need for any further processing, and the surface structure or topography which has been set may be maintained.

According to a further preferred refinement, at least one intermediate layer or at least one bonding layer or a combination of the two is provided between the predetermined surface of the machine or engine part and the amorphous hydrocarbon layer. The at least one intermediate layer is preferably in the form of a metal-containing hydrocarbon layer, wherein the metal components consisting of W, Ti, Hf, Ge or a combination of the abovementioned components. The thickness of the intermediate layer is advantageously from approximately 0.5 μm to 2.0 μm. The at least one bonding layer preferably consists of metallic substances, borides, carbides and/or nitrides of the transition metals. The bonding layer is preferably from approximately 0.1 μm to 0.5 μm thick.

According to a further preferred embodiment, the amorphous hydrocarbon layer is deposited on the predetermined surface of the machine part by a PVD or (PA)CVD process. The at least one intermediate layer and/or the at least one bonding layer is/are preferably deposited by means of a PVD process.

There is preferably no need to carry out any further thermal and/or mechanical processing of the deposited amorphous hydrocarbon layer.

According to a further preferred embodiment, the predetermined surface of the machine or engine part consists of 16MnCr5, 100Cr6, C45, 31CrMoV9, 80Cr2, or the like. In this case, the base body is carbonitrided and tempered prior to the coating operation, particularly if an inexpensive steel 16MnCr5 is used.

Examples of uses for the wear-resistant coating include coating an opposing runner layer on the sliding surfaces of a drag lever in the region of sliding contact with a camshaft. However, it is also possible for unmachined metal sheets, valve gear components, for example bucket tappets, hydraulic supporting and insertion elements, rolling bearing components, control pistons, release bearings, piston pins, bearing bushes, linear guides or the like to be provided with a wear-resistant coating of this type.

Other features and advantages of the present invention will become apparent from the following description of the invention which refers to the accompanying drawings.

### BRIEF DESCRIPTION OF THE DRAWINGS

The invention is explained in more detail below on the basis of exemplary embodiments and with reference to the appended Figures in which:

FIG. 1 shows a perspective view of a drag lever in accordance with an exemplary embodiment of the present invention;

FIG. 2 shows a cross-sectional view of the drag lever from FIG. 1 on section line A-A; and

FIG. 3 shows an enlarged view of excerpt B from the wear-resistant coating which has been deposited on the sliding surface of the drag lever in accordance with a preferred embodiment of the present invention.

### DESCRIPTION OF PREFERRED EMBODIMENTS

In the Figures, identical reference designations denote identical or functionally equivalent components unless stated otherwise.

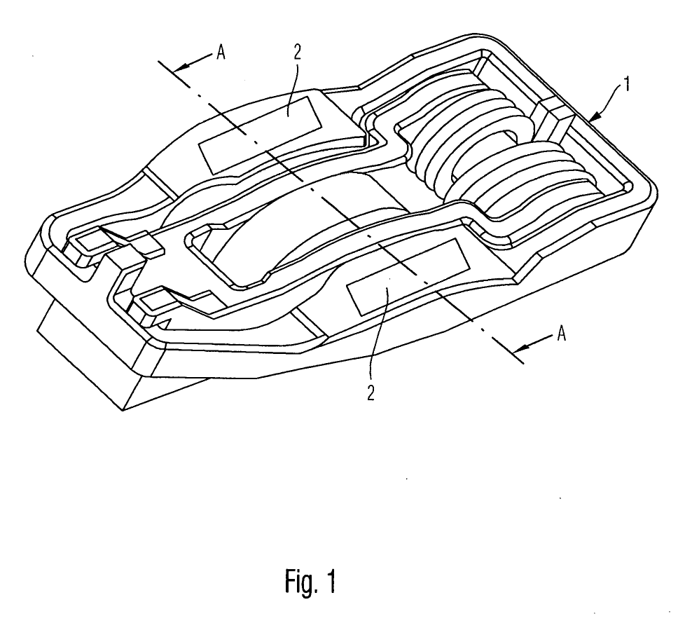

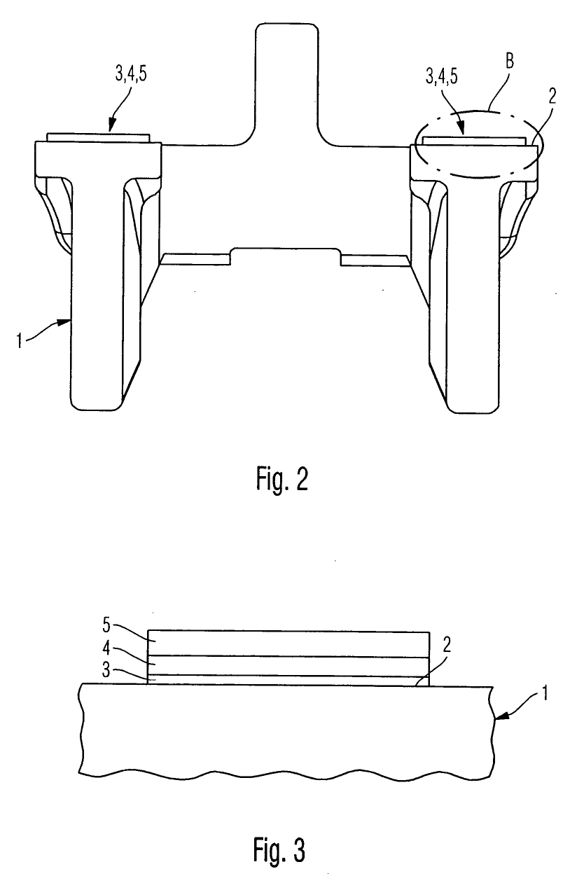

FIG. 1 illustrates a perspective view and FIG. 2 a cross-sectional view on line A-A from FIG. 1 of a shiftable drag lever 1 in accordance with an embodiment of the present invention. The lever is used in the valve gear of internal combustion engines for switching off valves/cylinders and/or switching over the valve stroke. According to the present embodiment, the drag lever 1 has two sliding surfaces 2 which are arranged symmetrically with respect to one another and against which a mating body, for example a camshaft (not shown), comes to bear frictionally. The drag lever 1, particularly in the region of the sliding surfaces 2, is subject to wear as a result of the frictional pairing with the associated camshaft. It is therefore desirable for these sliding surfaces 2 of the shifting lever 1 to be provided with wear protection or a wear-resistant coating, in order to increase the wear resistance of the drag lever so as to extend its service life.

FIG. 3 illustrates an enlarged view of excerpt B from FIG. 2. In FIG. 3, a wear-resistant coating 3, 4, 5 has been provided on a predetermined surface 2 of the drag lever 1 in order to increase the wear resistance and reduce the frictional torque.

According to a preferred embodiment of the invention, the base body of the drag lever is an inexpensive steel, such as for example 16MnCr5, 100Cr6, C45, 31CrMoV9, 80Cr2, or the like. Use of base body materials of this type enables use of conventional manufacturing technology. If the steel 16MnCr5 is used, the metallic base body is preferably carbonitrided and tempered before it is coated.

As is also illustrated in FIG. 2, a bonding layer 3 is applied to a predetermined surface or to the sliding surface 2 of the drag lever 1. The bonding layer 3 may be deposited on the predetermined surface 2 of the drag lever 1 for example by means of a PVD (Physical Vapor Deposition) process. The bonding layer 3 preferably consists of metallic substances, borides, carbides and nitrides of the transition metals, or the like, and is preferably from 0.1 μm to 0.5 μm thick. The bonding layer 3 is used to improve the bonding or linking of the atoms of an intermediate layer or functional layer which is subsequently to be applied to the base body 1. The thickness of the bonding layer 3 is selected as a function of the intermediate layer 4 used and/or the customer's wishes and requirements.

Then, according to the present embodiment, as seen in FIG. 3, an intermediate layer 4 is deposited on the bonding layer 3, for example, a PVD process once again. The intermediate layer 4 may, for example, be applied in the form of a metal-containing hydrocarbon layer (Me-C:H), in which case the metal component may be one or more of W, Ti, Hf, Ge or the like. The thickness of the intermediate layer 4 is, for example, from approximately 0.5 μm to 2.0 μm, and the intermediate layer 4 serves to improve the application of the functional layer to the bonding layer 3 or, if the bonding layer 3 is not present, to improve the application of the functional layer to the base body 1. The thickness of the intermediate layer 4 is once again to be adapted to compositions of the layers used and to the particular requirements.

As is also illustrated in FIG. 3, the actual functional layer 5 is then deposited on the intermediate layer 4. The functional layer 5 may be deposited either directly on the base body 1, directly on the bonding layer 3 or, as illustrated in FIG. 3, directly on the intermediate layer 4. At this point, it should be noted that for certain applications it is possible to do without the bonding layer 3 and/or the intermediate layer 4.

The functional layer 5 is in the form of an amorphous hydrocarbon layer (a-C:H) and is preferably deposited on an intended layer, according to the present embodiment on the intermediate layer 4, by means of a PVD and/or (PA)CVD (Plasma Assisted Chemical Vapor Deposition) process.

In the case of a PVD process, a starting material, for example graphite, is heated in such a manner that a beam of high-energy carbon ions is emitted from the graphite and guided toward the surface which is to be coated. The surface which is to be coated can be guided past the high-energy ion beam one or more times in a process chamber to form one or more layers.

In the case of a (PA)CVD process, a gas mixture is introduced, with the aid of a plasma, into the process chamber, which contains the material parts that are to be coated. At predetermined temperatures, the gases which have been introduced react chemically with one another and lead to a thin condensed layer on the surfaces of the material parts that are to be coated.

The purpose of the overall layer system, comprising the base body 1, the bonding layer 3, the intermediate layer 4 and the amorphous hydrocarbon layer 5, is to reduce the friction between this coating and a mating body, for example a camshaft, and to increase the service life of the coated drag lever and that of the mating body.

Therefore, the amorphous hydrocarbon layer 5 preferably has a hydrogen content of at most 16 atomic %, with the result that a low tendency to adhere to the metallic mating body, a high resistance to abrasive wear, a high chemical stability, high mechanical strengths and high hardness/elasticity modulus ratios are ensured. Otherwise, the amorphous hydrocarbon layer 5 consists of sp²- and sp³-hybridized carbon, which preferably contains less than 1 atomic % of process-related impurities.

The amorphous hydrocarbon layer 5 preferably has a layer thickness of approximately 0.8 μm to 2.5 μm. The overall thickness of the coating, comprising the individual layers 3, 4, and 5, is preferably approximately 0.5 μm to 5.0 μm. This type of thickness of the overall coating causes the dimensions of the machine or engine part or drag lever 1 to change only to such a slight extent that there is no need for any further processing and the surface structure or topography which has been set is maintained. The tribological roll is now performed by the surface of the coating, which on account of the structure which has been set reduces the mixed friction region and, on account of the low-friction coating, reduces the frictional force and consequently the surface loads. The mechanical tasks, on the other hand, are performed by the layer system in combination with the base body.

Iron-carbon alloys can preferably be used to form the mating body, in the present case, for example, the camshaft, with a view to achieving a lightweight structure and to save costs. Furthermore, it is possible to use low-viscosity oils with low additive levels. Moreover, minimal lubrication or a longer oil change interval can be implemented.

The coating which is explained in more detail above can be applied to the outer and inner levers of a drag lever, which are produced by various manufacturing processes, for example casting, sintering, etc.

Furthermore, the various processes can preserve specially structured surfaces, for example cross-honed or cross-honed and structured surfaces. After the surface structure has been produced and the desired contour has been set, the surface which has been established in this way is protected from wear, for example by coating by means of a PVD and/or (PA)CVD process. The coating described above produces a tribological system which, by virtue of the structure which has been set, reduces the mixed friction region and, on account of the low-friction coating, reduces the frictional force and consequently the surface loading and the wear resistance.

In addition to coating sliding surfaces of drag levers, it is, of course, also possible to coat other machine or engine parts, for example unmachined metal sheet surfaces, other valve gear components, such as for example bucket tappets, hydraulic supporting and insertion elements, rolling bearing components, control pistons, release bearings, piston pins, bearing bushes, linear guides or the like.

Although the present invention has been described above on the basis of preferred exemplary embodiments, it is not restricted to these embodiments, but rather can be modified in numerous ways.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A wear-resistant coating for a surface of a part for a machine or an engine which is exposed to frictional wear, comprising at least one metal-free, amorphous hydrocarbon layer which includes sp²- and sp³-hybridized carbon applied to the surface of the machine or engine part, for reducing friction and increasing the wear resistance of the surface of the machine or engine part.

2. The wear-resistant coating as claimed in claim 1, wherein the amorphous hydrocarbon layer has a hydrogen content of at most 16 atomic %.

3. The wear-resistant coating as claimed in claim 1, wherein the amorphous hydrocarbon layer includes less than 1 atomic % of process-related impurities.

4. The wear-resistant coating as claimed in claim 1, wherein the amorphous hydrocarbon layer (5) is approximately 0.8 μm to 2.5 μm thick.

5. The wear-resistant coating as claimed in claim 1, further comprising at least one of a bonding layer and an intermediate layer between the predetermined surface of the machine or engine part and the amorphous hydrocarbon layer.

6. The wear-resistant coating as claimed in claim 5, wherein the at least one intermediate layer is a metal-containing hydrocarbon layer.

7. The wear-resistant coating as claimed in claim 6, wherein the metal-containing hydrocarbon layer includes at least one of metal components selected from the group consisting of W, Ti, Hf, Ge and a combination of these components.

8. The wear-resistant coating as claimed in claim 5, wherein the at least one intermediate layer is from approximately 0.5 μm to 2.0 μm thick.

9. The wear-resistant coating as claimed in claim 5, wherein the at least one bonding layer consists of at least one of the group consisting of metallic substances, borides, carbides and nitrides of foregoing transition metals.

10. The wear-resistant coating as claimed in claim 5, wherein the bonding layer is approximately 0.1 μm to 0.5 μm thick.

11. The wear-resistant coating as claimed in claim 1, wherein the surface of the machine or engine part consists of at least one of 16MnCr5, 100Cr6, C45, 31CrMoV9, 80Cr2.

12. A process for producing a wear-resistant coating on a surface of a machine or an engine part which is exposed to frictional comprising the steps of:
applying at least one metal-free amorphous hydrocarbon layer comprising sp²- and Sp³-hybridized carbon to the surface of the machine part for reducing friction and increasing the wear resistance of the surface.

13. The process as claimed in claim 12, further comprising applying by depositing the amorphous hydrocarbon layer on the surface of the machine part by at least one of a PVD and a (PA)CVD process.

14. The process as claimed in claim 12, wherein the amorphous hydrocarbon layer has a hydrogen content of at most 16 atomic %.

15. The process as claimed in claim 12, wherein the amorphous hydrocarbon layer has less than 1 atomic % of process-related impurities.

16. The process as claimed in at least one of claims 12, wherein the amorphous hydrocarbon layer has a thickness of approximately 0.8 μm to 2.5 μm.

17. The process as claimed in claim 12, wherein no further thermal or mechanical processing is performed on the deposited amorphous hydrocarbon layer.

18. The process as claimed in claim 13, wherein prior to depositing the amorphous hydrocarbon layer, carbonitriding and tempering the predetermined surface of the machine or engine part.

19. The process as claimed in claim 12, wherein prior to applying the amorphous hydrocarbon layer, carbonitriding and tempering the predetermined surface of the machine or engine part.

20. The process as claimed in claim 12, further comprising forming at least one of a bonding layer and one intermediate layer between the surface of the machine or engine part and the amorphous hydrocarbon layer.

21. The process as claimed in claim 19, wherein the at least one intermediate layer is formed as a metal-containing hydrocarbon layer.

22. The process as claimed in claim 22, wherein the metal-containing hydrocarbon layer includes metal selected from the group consisting of W, Ti, Hf, Ge and a combination of at least some of the metals.

23. The process as claimed in claim 19, wherein the at least one intermediate layer is formed with a thickness of approximately 0.5 μm to 2.0 μm.

24. The process as claimed in claim 19, wherein the at least one bonding layer is formed from metallic substances, borides, carbides or nitrides of the transition metals.

25. The process as claimed in claim 19, wherein the at least one bonding layer is formed in a thickness of approximately 0.1 μm to 0.5 μm.
